(19) United States
(12) Patent Application Publication
(10) Pub. No.: US 2013/0141358 A1
(43) Pub. Date: Jun. 6, 2013

(54) ELECTRONIC DEVICE AND METHOD FOR SWITCHING BETWEEN A PLURALITY OF USER INTERFACES

(71) Applicant: HONG-SHENG CHEN, Tu-Cheng (TW)

(72) Inventor: HONG-SHENG CHEN, Tu-Cheng (TW)

(73) Assignee: HON HAI PRECISION INDUSTRY CO., LTD., Tu-Cheng (TW)

(21) Appl. No.: 13/609,625

(22) Filed: Sep. 11, 2012

(30) Foreign Application Priority Data
Dec. 5, 2011 (TW) 100144738

(51) Int. Cl. G06F 3/041

(52) U.S. Cl. 345/173

(57) ABSTRACT

An electronic device includes a physical touch pad having a touch sensor, a processing unit, and a display unit. The display unit displays a plurality of user interfaces having different ranks and switches from displaying one user interface having a rank that is lower than or higher than a rank of other user interface by one rank to displaying the other user interface. The user interface having a highest rank is defined as a last user interface. The touch sensor generates a first touch control signal when the touch sensor detects that a first slide operation is executed on a current user interface. The processing unit controls the display unit to switch from displaying the current user interface having the rank that is lower than the rank of the last user interface by more than one rank to displaying the last user interface according to the first touch control signal.

### BACKGROUND

1. Technical Field

The disclosed embodiments relate to an electronic device and a method for switching between a plurality of user interfaces.

2. Description of Related Art

Electronic devices, such as mobile phones, include a display unit and a physical touch pad mounted to the display unit. Generally, the display unit is capable of displaying a plurality of user interfaces, such as three user interfaces, that is a first user interface, a second user interface, and a third user interface.

However, when the display unit needs to switch from displaying the first user interface to displaying the third user interface, the user must perform a specific slide operation on the first user interface via the physical touch pad, so the display unit is switched to displaying the second user interface accordingly. Then, the user must perform the specific slide operation on the second user interface via the physical touch pad, so the display unit is switched to displaying the third user interface accordingly. That is, when the user performs the specific slide operation on the first user interface via the physical touch pad, the display unit cannot be switched directly from displaying the first user interface to displaying the third user interface. Therefore, it is inconvenient for users.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout two views.

FIG. 1 is a block diagram of an electronic device in accordance with an embodiment, the electronic device includes a display unit.

FIG. 2 is flowchart showing a method for switching between a plurality of user interfaces displayed by the display unit of FIG. 1 in accordance with a first embodiment.

### DETAILED DESCRIPTION

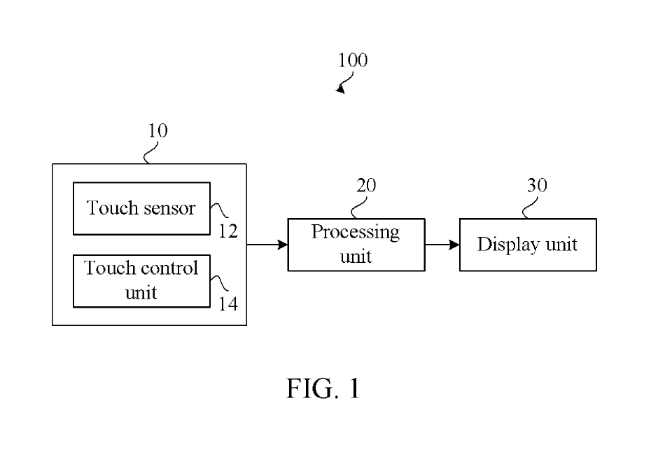

Referring to FIG. 1, an electronic device 100 includes a physical touch pad 10, a processing unit 20, and a display unit 30. The physical touch pad 10 can be translucent and can be juxtaposed over the display unit 30 to constitute a touch screen. The display unit 30 is capable of displaying a plurality of user interfaces, for example moving picture experts group audio layer-3 (MP3) player program interface, global position system (GPS) program interface, personal digital assistant (PDA) phone interface, image display program interface, etc. Each user interface includes a plurality of virtual targeting items for being touched by a user on the touch screen to control the processing unit 20 to perform a specific function, for example, audio playing function, video playing function, etc.

The plurality of user interfaces have different ranks, the user interface having a lowest rank is defined as a first user interface, and the user interface having a highest rank is defined as a last user interface. The display unit 30 is capable of switching from displaying one user interface having a rank that is lower than or higher than the rank of other user interface by one rank to displaying the other user interface.

The physical touch pad 10 includes a touch sensor 12 and a touch control unit 14. The touch sensor 12 generates a first touch control signal when the touch sensor 12 detects that a first slide operation is executed on a current user interface currently displayed by the display unit 30. Here, the slide operation refers to, if it is performed by human contact, an operation in which a finger moves and is in continuous contact with the touch screen. The processing unit 20 controls the display unit 30 to switch from displaying the current user interface having a rank that is lower than the rank of the last user interface by more than one rank to displaying the last user interface according to the first touch control signal. In this embodiment, the current user interface can be the first user interface.

The touch sensor 12 further generates a second touch control signal when the touch sensor 12 detects that a second slide operation is executed on the current user interface. The processing unit 20 controls the display unit 30 to switch from displaying the current user interface having the rank that is higher than the rank of the first user interface by more than one rank to displaying the first user interface according to the second touch control signal. In this embodiment, the current user interface can be the last user interface.

In a first embodiment, the touch control unit 14 calculates a duration time of a slide operation executed on the current user interface and detects a slide direction of the slide operation. The touch control unit 14 determines the slide operation as the first slide operation when the touch control unit 14 determines that the duration time is longer than a first predetermined time interval and the touch control unit 14 determines that the slide direction is a downward direction or a rightward direction.

The touch control unit 14 further determines the slide operation as the second slide operation when the touch control unit 14 determines that the duration time is longer than the first predetermined time interval and the touch control unit 14 determines that the slide direction is an upward direction or a leftward direction.

In a second embodiment, the touch control unit 14 calculates a total number of slide operations executed on the current user interface and detects a slide direction of the slide operation. The touch control unit 14 determines the slide operation as the first slide operation when the touch control unit 14 determines that the total number of slide operations is larger than a predetermined number and the touch control unit 14 determines that the slide direction is a downward direction or a rightward direction.

The touch control unit 14 further determines the slide operation as the second slide operation when the touch control unit 14 determines that the total number of slide operations is larger than the predetermined number and the touch control unit 14 determines that the slide direction is an upward direction or a leftward direction. In this embodiment, the total number of slide operations executed on the current user interface is calculated by the touch control unit 14 within a second predetermined time interval.

In a third embodiment, the first slide operation includes at least two sub-slide operations, the at least two sub-slide operations includes a most recent sub-slide operation and a previous one sub-slide operation relative to the most recent sub-slide operation. A slide distance of the most recent sub-slide operation calculated by the touch control unit 14 is longer than the slide distance of the previous one sub-slide operation calculated by the touch control unit 14. A further precondition of the first slide operation is that a slide direction of the most recent sub-slide operation detected by the touch control unit 14 is in an upward direction whereas the slide direction of the previous one sub-slide operation detected by the touch control unit 14 is in a downward direction. Alternatively, a slide direction of the most recent sub-slide operation is a leftward direction and the slide direction of the previous one sub-slide operation is a rightward direction.

The second slide operation includes at least two sub-slide operations, the at least two sub-slide operations includes a most recent sub-slide operation and a previous one sub-slide operation relative to the most recent sub-slide operation. The slide distance of the most recent sub-slide operation calculated by the touch control unit 14 is longer than the slide distance of the previous one sub-slide operation calculated by the touch control unit 14. Also, that a slide direction of the most recent sub-slide operation detected by the touch control unit 14 is a downward direction and the slide direction of the previous one sub-slide operation detected by the touch control unit 14 is an upward direction. Alternatively, a slide direction of the most recent sub-slide operation is a rightward direction and the slide direction of the previous one sub-slide operation is a leftward direction.

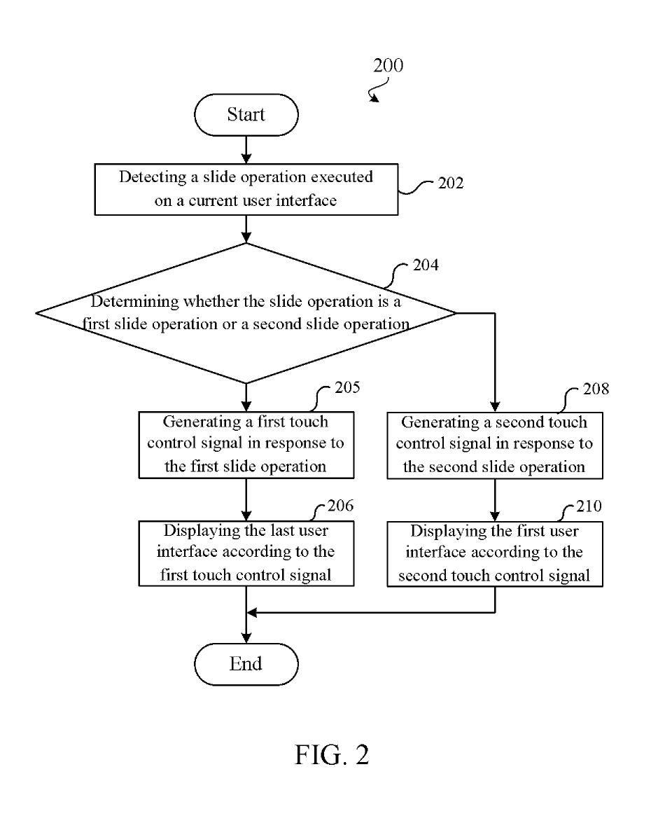

Referring to FIG. 2, a method 200 for switching between a plurality of user interfaces is illustrated. The electronic device 100 implements the method 200. The method 200 includes the following steps.

Step 202, the touch sensor 12 detects a slide operation executed on a current user interface currently displayed by the display unit 30.

Step 204, the touch control unit 14 determines whether the slide operation is a first slide operation or a second slide operation. If it is determined that the slide operation is the first slide operation, the procedure goes to step 205. If it is determined that the slide operation is the second slide operation, the procedure goes to step 208.

Step 205, the touch sensor 12 generates a first touch control signal in response to a finding of a first slide operation.

Step 206, the processing unit 20 controls the display unit 30 to switch from displaying the current user interface having a rank that is lower than a rank of the last user interface to displaying the last user interface according to the first touch control signal.

Step 208, the touch sensor 12 generates a second touch control signal in response to a finding of a second slide operation.

Step 210, the processing unit 20 controls the display unit 30 to switch from displaying the current user interface having the rank that is higher than a rank of the first user interface to displaying the first user interface according to the second touch control signal.

The detailed steps for determining the first user interface and the second user interface are disclosed in the electronic device, which detailed steps are omitted for clarity.

In the electronic device 100 and the method 200, in response to the first slide operation on the first user interface (if the current user interface) displayed by the display unit 30, the processing unit 20 can control the display unit 30 to switch from displaying the first user interface to displaying the last user interface, therefore the display unit 30 can immediately display the last user interface. Alternatively, in response to the second slide operation on the last user interface (if the current user interface) displayed by the display unit 30, the processing unit 20 can control the display unit 30 to switch from displaying the last user interface to displaying the first user interface, therefore the display unit 30 can immediately display the first user interface. This greatly increases convenience for the user.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An electronic device, comprising:
a physical touch pad comprising a touch sensor;
a processing unit; and
a display unit that displays a plurality of user interfaces of the electronic device having different ranks and switching from displaying one user interface having a rank that is lower than or higher than a rank of other user interface by one rank to displaying the other user interface, the user interface having a highest rank defined as a last user interface;
wherein the touch sensor generates a first touch control signal when the touch sensor detects that a first slide operation is executed on a current user interface currently displayed by the display unit; and the processing unit controls the display unit to switch from displaying the current user interface having a rank that is lower than the rank of the last user interface by more than one rank to displaying the last user interface according to the first touch control signal.

2. The electronic device of claim 1, wherein the user interface having a lowest rank is defined as a first user interface, the touch sensor generates a second touch control signal when the touch sensor detects that a second slide operation is executed on the current user interface, and the processing unit controls the display unit to switch from displaying the current user interface having the rank that is higher than the rank of the first user interface by more than one rank to displaying the first user interface according to the second touch control signal.

3. The electronic device of claim 1, wherein the physical touch pad further comprises a touch control unit, the touch control unit calculates a duration time of a slide operation executed on the current user interface and detects a slide direction of the slide operation, and the touch control unit determines the slide operation as the first slide operation when the touch control unit determines that the duration time is longer than a first predetermined time interval and the touch control unit determines that the slide direction is a downward direction or a rightward direction.

4. The electronic device of claim 2, wherein the physical touch pad further comprises a touch control unit, the touch control unit calculates a duration time of a slide operation executed on the current user interface and detects a slide direction of the slide operation, and the touch control unit determines the slide operation as the second slide operation when the touch control unit determines that the duration time is longer than a first predetermined time interval and the touch control unit determines that the slide direction is an upward direction or a leftward direction.

5. The electronic device of claim 1, wherein the physical touch pad further comprises a touch control unit, the touch control unit calculates a total number of slide operations executed on the current user interface and detects a slide direction of the slide operation, and the touch control unit determines the slide operation as the first slide operation when the touch control unit determines that the total number of slide operations is larger than a predetermined number and the touch control unit determines that the slide direction is a downward direction or a rightward direction.

6. The electronic device of claim 2, wherein the physical touch pad further comprises a touch control unit, the touch control unit calculates a total number of slide operations executed on the current user interface and detects a slide direction of the slide operation, and the touch control unit determines the slide operation as the second slide operation when the touch control unit determines that the total number of slide operations is larger than a predetermined number and the touch control unit determines that the slide direction is an upward direction or a leftward direction.

7. The electronic device of claim 5, wherein the total number of slide operations executed on the current user interface is calculated by the touch control unit within a second predetermined time interval.

8. The electronic device of claim 1, wherein the first slide operation comprises at least two sub-slide operations, the at least two sub-slide operations comprises a most recent sub-slide operation and a previous one sub-slide operation relative to the most recent sub-slide operation, a slide distance of the most recent sub-slide operation is longer than the slide distance of the previous one sub-slide operation; a slide direction of the most recent sub-slide operation is an upward direction and the slide direction of the previous one sub-slide operation is a downward direction.

9. The electronic device of claim 1, wherein the first slide operation comprises at least two sub-slide operations, the at least two sub-slide operations comprises a most recent sub-slide operation and a previous one sub-slide operation relative to the most recent sub-slide operation, a slide distance of the most recent sub-slide operation is longer than the slide distance of the previous one sub-slide operation; a slide direction of the most recent sub-slide operation is a leftward direction and the slide direction of the previous one sub-slide operation is a rightward direction.

10. The electronic device of claim 1, wherein the second slide operation comprises at least two sub-slide operations, the at least two sub-slide operations comprises a most recent sub-slide operation and a previous one sub-slide operation relative to the most recent sub-slide operation, a slide distance of the most recent sub-slide operation is longer than the slide distance of the previous one sub-slide operation; a slide direction of the most recent sub-slide operation is a downward direction and the slide direction of the previous one sub-slide operation is an upward direction.

11. The electronic device of claim 1, wherein the second slide operation comprises at least two sub-slide operations, the at least two sub-slide operations comprises a most recent sub-slide operation and a previous one sub-slide operation relative to the most recent sub-slide operation, a slide distance of the most recent sub-slide operation is longer than the slide distance of the previous one sub-slide operation; a slide direction of the most recent sub-slide operation is a rightward direction and the slide direction of the previous one sub-slide operation is a leftward direction.

12. A method for switching between a plurality of user interfaces, the plurality of user interfaces having different ranks and capable of being displayed by a display unit, the display unit further capable of switching from displaying one user interface having a rank that is lower than or higher than the rank of other user interface by one rank to displaying the other user interface, the user interface having a highest rank defined as a last user interface; the method comprising the steps of:
detecting a slide operation executed on a current user interface currently displayed by the display unit;
determining whether the slide operation is a first slide operation;
responding to the first slide operation to generate a first touch control signal when it is determined that the slide operation is the first slide operation; and
controlling the display unit to switch from displaying the current user interface having a rank that is lower than the rank of the last user interface by more than one rank to displaying the last user interface according to the first touch control signal.

13. The method of claim 12, wherein the user interface having a lowest rank is defined as a first user interface, the method further comprises the steps of:
determining whether the slide operation is a second slide operation;
responding to the second slide operation to generate a second touch control signal when it is determined that the slide operation is the second slide operation; and
controlling the display unit to switch from displaying the current user interface having the rank that is higher than the rank of the first user interface by more than one rank to displaying the first user interface according to the second touch control signal.

14. The method of claim 12, wherein the step of “determining whether the slide operation is a first slide operation” further comprises the sub-steps of:
calculating a duration time of the slide operation executed on the current user interface and detecting a slide direction of the slide operation; and
determining the slide operation as the first slide operation when it is determined that the duration time is longer than a first predetermined time interval and it is determined that the slide direction is a downward direction or a rightward direction.

15. The method of claim 13, wherein the step of “determining whether the slide operation is a second slide operation” further comprises the sub-steps of:
calculating a duration time of the slide operation executed on the current user interface and detecting a slide direction of the slide operation; and
determining the slide operation as the second slide operation when it is determined that the duration time is longer than a first predetermined time interval and it is determined that the slide direction is an upward direction or a leftward direction.

16. The method of claim 12, wherein the step of “determining whether the slide operation is a first slide operation” further comprises the sub-steps of:
calculating a total number of slide operations executed on the current user interface and detecting a slide direction of the slide operation; and
determining the slide operation as the first slide operation when determining that the total number of slide operations is larger than a predetermined number and determining that the slide direction is a downward direction or a rightward direction.

17. The method of claim 13, wherein the step of “determining whether the slide operation is a second slide operation” further comprises the sub-steps of:
calculating a total number of slide operations executed on the current user interface and detecting a slide direction of the slide operation; and
determining the slide operation as the second slide operation when it is determined that the total number of slide operations is larger than a predetermined number and it is determined that the slide direction is an upward direction or a leftward direction.

18. The method of claim 12, wherein the first slide operation comprises at least two sub-slide operations, the at least two sub-slide operations comprises a most recent sub-slide operation and a previous one sub-slide operation relative to the most recent sub-slide operation, a slide distance of the most recent sub-slide operation is longer than the slide distance of the previous one sub-slide operation; a slide direction of the most recent sub-slide operation is an upward direction and the slide direction of the previous one sub-slide operation is a downward direction.

19. The method of claim 12, wherein the first slide operation comprises at least two sub-slide operations, the at least two sub-slide operations comprises a most recent sub-slide operation and a previous one sub-slide operation relative to the most recent sub-slide operation, a slide distance of the most recent sub-slide operation is longer than the slide distance of the previous one sub-slide operation; a slide direction of the most recent sub-slide operation is a leftward direction and the slide direction of the previous one sub-slide operation is a rightward direction.

20. The method of claim 12, wherein the second slide operation comprises at least two sub-slide operations, the at least two sub-slide operations comprises a most recent sub-slide operation and a previous one sub-slide operation relative to the most recent sub-slide operation, a slide distance of the most recent sub-slide operation is longer than the slide distance of the previous one sub-slide operation; a slide direction of the most recent sub-slide operation is a downward direction and the slide direction of the previous one sub-slide operation is an upward direction; or a slide direction of the most recent sub-slide operation is a rightward direction and the slide direction of the previous one sub-slide operation is a leftward direction.
